(19) United States
(12) Patent Application Publication
(10) Pub. No.: US 2017/0113591 A1
(43) Pub. Date: Apr. 27, 2017

(54) SYSTEM AND METHOD FOR CONTROLLING MOVEMENT OF IMPLEMENT

(71) Applicant: Caterpillar Inc., Peoria, IL (US)

(72) Inventors: Michael A. Spielman, JR., Brookfield, IL (US); Eric W. Cler, Oswego, IL (US); Aaron R. Shatters, Montgomery, IL (US)

(73) Assignee: Caterpillar Inc., Peoria, IL (US)

(21) Appl. No.: 14/923,707

(22) Filed: Oct. 27, 2015

(51) Int. Cl. B60P 1/34; B60P 3/00

(52) U.S. Cl. CPC B60P 1/34; B60P 3/00

(57) ABSTRACT

A system for controlling a movement of an implement during a dump operation is provided. The system includes a payload detection module associated with the implement. The payload detection module is configured to generate a signal indicative of a current weight of payload in the implement. The payload detection module determines the current weight of payload during a controlled lifting motion of the implement. The system also includes a control module communicably coupled to the payload detection module.

### TECHNICAL FIELD

The present disclosure relates to a system and a method for controlling a movement of an implement, and more particularly to controlling a movement of an implement during a dump operation.

### BACKGROUND

An operator of a machine, such as a wheel loader, may have to load a target amount of payload into a truck. The payload is generally held in an implement of the machine. It is essential that the truck is accurately loaded with the payload as an under loaded or over loaded condition of the truck is undesirable from productivity and efficiency standpoint.

In order to achieve the target payload in the truck, the operator typically adjusts the amount of payload in the implement to be dumped or dumps only a partial amount from the implement into the truck. This action is referred to as “tipping”. Tipping the right amount of payload requires a considerable amount of experience. In order to aid the operator, some machines include a tipoff feature that provides an indication of the amount of payload present in the implement. However, in order to become effective with the tipoff feature, the operator must have a very consistent operating technique which may be difficult to achieve and maintain.

U.S. Pat. No. 5,220,968 describes a device for loading and moving loads, for example, a wheeled loader, track type loader, shovel loader, crane, scraper, back hoe, etc., is equipped with various sensors for determining when a load is being moved and what the weight and volume of the load is. A display can provide the operator with information regarding the load. The same display can be used to provide data regarding the efficiency and productivity of the operator during a work period. A printer is also provided to print out the data.

### SUMMARY OF THE DISCLOSURE

In one aspect of the present disclosure, a system for controlling a movement of an implement during a dump operation is provided. The system includes a payload detection module associated with the implement. The payload detection module is configured to generate a signal indicative of a current weight of payload in the implement. The payload detection module determines the current weight of payload during a controlled lifting motion of the implement. The system also includes a control module communicably coupled to the payload detection module. The control module is configured to receive the signal indicative of the current weight of payload in the implement. The control module is also configured to compare the current weight of payload with a predetermined threshold. The control module is further configured to calculate an amount of payload to be dumped from the implement, based on the comparison. The control module is configured to control the movement of the implement to dump the calculated amount of payload from the implement.

In another aspect of the present disclosure, a method of controlling a movement of an implement during a dump operation is provided. The method includes generating a signal indicative of a current weight of payload in the implement during a controlled lifting motion of the implement. The method also includes comparing the current weight of payload with a predetermined threshold. The method further includes calculating an amount of payload to be dumped from the implement, based on the comparison. The method includes controlling the movement of the implement to dump the calculated amount of payload from the implement.

In yet another aspect of the present disclosure, a machine is provided. The machine includes a frame and a linkage member coupled to the frame. The machine also includes an implement coupled to the linkage member. The implement is configured to hold payload therein. The machine further includes a payload detection module associated with the implement. The payload detection module is configured to generate a signal indicative of a current weight of payload in the implement. The payload detection module determines the current weight of payload during a controlled lifting motion of the implement. The machine includes a control module communicably coupled to the payload detection module. The control module is configured to receive the signal indicative of the current weight of payload in the implement. The control module is also configured to compare the current weight of payload with a predetermined threshold. The control module is further configured to calculate an amount of payload to be dumped from the implement, based on the comparison. The control module is configured to control a movement of the implement to raise and dump the calculated amount of payload from the implement.

Other features and aspects of this disclosure will be apparent from the following description and the accompanying drawings.

### BRIEF DESCRIPTION OF THE DRAWINGS

FIG. 1 is a side view of an exemplary machine deployed at a worksite, according to an aspect of the present disclosure;

FIG. 2 is a side view of an implement of the machine shown in FIG. 1;

FIG. 3 is a block diagram of a system for controlling a movement of the implement, according to an aspect of the present disclosure; and

FIG. 4 is a flowchart for a method of controlling the movement of the implement.

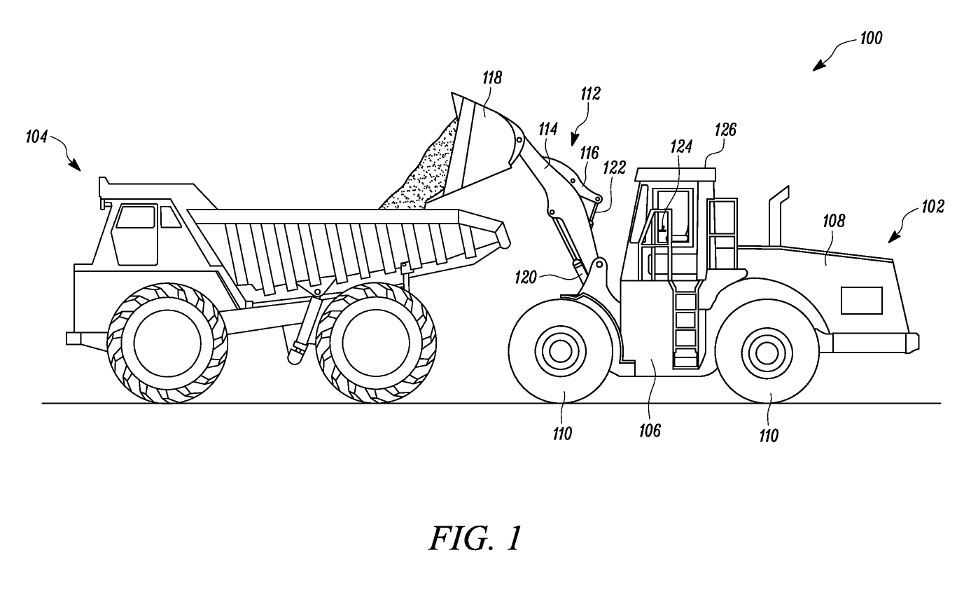

### DETAILED DESCRIPTION

Wherever possible, the same reference numbers will be used throughout the drawings to refer to the same or the like parts. FIG. 1 represents an exemplary worksite 100, according to one embodiment of the present disclosure. A machine 102 is deployed at the worksite 100. More specifically, the machine 102 is a wheel loader. Alternatively, the machine 102 may include, but not limited to, a backhoe loader, a skid steer loader, a track type tractor, excavator, and the like. It should be understood that the machine 102 may embody any wheeled or tracked machine associated with mining, agriculture, forestry, construction, and other industrial applications.

The machine 102 may perform various operations at the worksite 100. In one example, the machine 102 may perform a dump operation. More particularly, the machine 102 may dump payload into a truck 104. The truck 104 may include machines, such as, a dump truck, a mining truck, or any other machine that is capable of holding and transporting the payload from one place to another. Alternatively, the machine 102 may dump the payload in a pile at the worksite 100.

The machine 102 includes a frame 106. A powertrain (not shown) may be provided on the machine 102 for production and transmission of motive power. The powertrain may include a power source located within an enclosure 108 of the machine 102. The power source may include one or more engines, power plants or other power delivery systems like batteries, hybrid engines, and the like. In one embodiment, the engine may include, for example, a diesel engine, a gasoline engine, a gaseous fuel powered engine like a natural gas engine, or any other known source of power. It should be noted that the power source could also be external to the machine 102.

A set of ground engaging members 110, such as wheels, is provided on the machine 102 for the purpose of mobility. The powertrain may further include a torque converter, a transmission system inclusive of gearing, drive shaft, and other known drive links provided between the power source and the set of ground engaging members 110 for the transmission of the motive power.

The machine 102 includes a linkage assembly 112 attached to the frame 106. The linkage assembly 112 includes a linkage member 114 and a support arm 116. An implement 118, such as a bucket, may be pivotally coupled to the linkage member 114. The implement 118 of the linkage assembly 112 may be configured to collect, hold and convey any material and/or object at the worksite 100. It may be noted that the linkage assembly 112 and the implement 118 of the machine 102 may vary based on the type of machine or the type of operation or task required to be carried out by the machine 102.

During operation of the machine 102, the linkage member 114 and the implement 118 may be moved to different positions in order to perform dump operations. A hydraulic system or a pneumatic system (not shown) may be used to effectuate a movement of the linkage member 114, the support arm 116, and/or the implement 118 of the linkage assembly 112. For example, a lift cylinder 120 and a tilt cylinder 122 may effectuate and control the movement of the implement 118. The cylinders 120, 122 may embody any one of a hydraulic cylinder or a pneumatic cylinder. Based on the movement of the linkage member 114 and the implement 118, the machine 102 may perform different operations such as loading, dumping, excavating, and the like.

Further, the machine 102 includes an operator cabin 126. The operator cabin 126 may include an operator interface having a number of input devices, such as levers, knobs, switches, that are adapted to control and operate the machine 102. The input device may include a lever 124. In one example, the lever 124 may be adapted to stop an ongoing dump operation. The operator cabin 126 may also include one or more display devices.

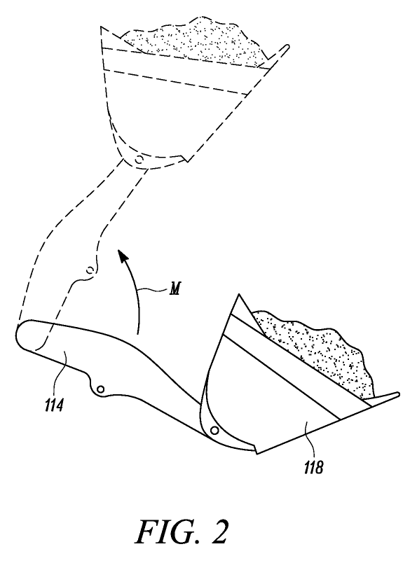

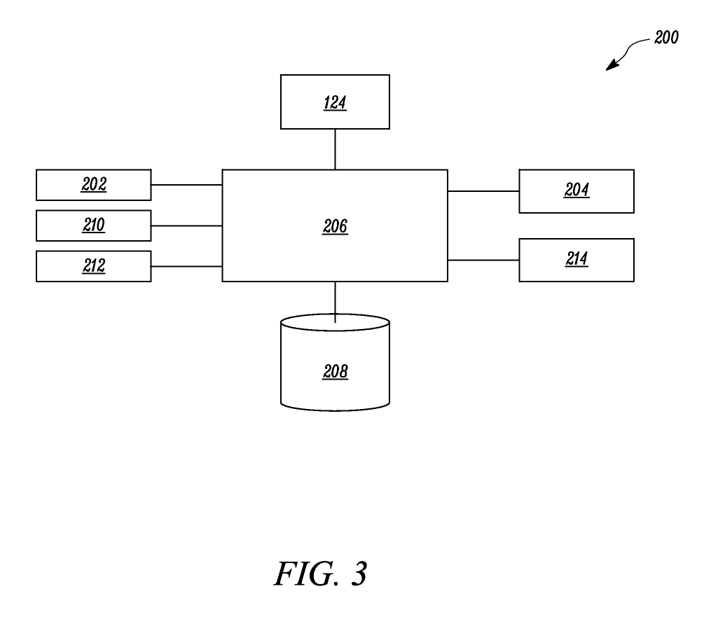

Referring to FIG. 2, the dump operation of the payload may require tipping of a desired amount of payload from the implement 118. The term “tipping” referred to herein may be defined as a process of dumping a partial amount of payload from the implement 118 into the truck 104 or the pile, based on operational requirements. The present disclosure relates to a system 200 (see FIG. 3) for controlling the movement of the implement 118 during the dump operation for tipping the desired amount of payload from the implement 118.

Referring to FIG. 3, the system 200 includes a payload detection module 202. The payload detection module 202 generates a signal indicative of a current weight of payload in the implement 118 (see FIGS. 1 and 2). The payload detection module 202 measures the current weight of payload in the implement 118 during a controlled lifting motion “M” (shown using arrow in FIG. 2) of the implement 118. The system 200 includes a hydraulic implement controller 204. The hydraulic implement controller 204 includes a control module and one or more hydraulic valves. The hydraulic implement controller 204 is communicably coupled with the lift and tilt cylinders 120, 122. During the measurement of the current weight of payload, the hydraulic valve associated with the hydraulic implement controller 204 sends signals to the lift cylinder 120 in order to control the lifting motion “M” of the implement 118.

The payload detection module 202 may include one or more sensing devices (not shown) that allow direct/indirect measurement of the current weight of payload in the implement 118. In one example, the sensing devices may include pressure sensors. The pressure sensors may be coupled to the lift cylinder 120 and the tilt cylinder 122. More particularly, a lift pressure sensor and a tilt pressure sensor may be associated with the lift cylinder 120 and the tilt cylinder 122, respectively, to enable detection of a pressure of fluid within the respective cylinders 120, 122.

In an alternate example, the payload detection module 202 may include sensing devices that are coupled to the implement 118. The sensing devices may be configured to generate a signal indicative of shear forces acting on the implement 118. The shear forces may act as a contributory parameter in the measurement of the current weight of payload in the implement 118. The sensing devices may include sensors, such as strain sensors, load cells, pressure transducers, etc., without any limitations. In one example, the sensing devices may include any one or a combination of strain sensors and/or load cells known to one skilled in the art. For example, the sensing devices may be a foil or wire type strain sensor, film type strain sensor, semiconductor strain sensor, bonded resistance strain sensor, capacitive strain sensor, hydraulic load cell, pneumatic load cell, strain gauge load cell, or any other sensor configured to detect and/or measure shear forces.

It should be noted that the payload detection module 202 may include any another sensor or set of sensors, that enable measurement/calculation of the current weight of payload in the implement 118. In one example, the payload detection module 202 may include logics to calculate the current weight of payload using signals received from the sensing devices that are communicably coupled with the payload detection module 202.

The system 200 includes a control module 206. The control module 206 is adapted to control the movement of the implement 118 during the dump operation. An operator of the machine 102 may activate or deactivate the control module 206 by operating the lever 124 present in the operator cabin 126. The lever 124 is communicably coupled to the control module 206. Further, the control module 206 is also communicably coupled to the payload detection module 202 and the hydraulic implement controller 204. Based on signals received from the control module 206, the hydraulic valves associated with the hydraulic implement controller 204 controls the lift and tilt cylinders 120, 122.

The control module 206 receives signals from the payload detection module 202. In one example, where the payload detection module 202 calculates the current weight of payload in the implement 118, the control module 206 receives the signals indicative of the current weight of payload from the payload detection module 202. In another example, the payload detection module 202 may send signals corresponding to the parameters determined by the sensing devices to the control module 206. In such an example, the control module 206 may calculate the current weight of payload in the implement 118. Accordingly, the control module 206 may include logics that allow calculation of the current weight of payload from the parameters determined by the sensing devices.

The control module 206 is also communicably coupled with a database 208. The data storage device 208 may store values corresponding to a predetermined threshold. The predetermined threshold corresponds to a target weight of payload that needs to be dumped into the truck 104. The control module 206 is adapted to retrieve the values corresponding to the predetermined threshold from the data storage device 208.

The control module 206 compares the current weight of payload in the implement 118 with the predetermined threshold. Based on the comparison between the current weight of payload in the implement 118 and the predetermined threshold, the control module 206 calculates an amount of payload that needs to be dumped from the implement 118.

Based on the calculated amount of payload, the control module 206 sends signals to the hydraulic valves to control an operation of the lift and tilt cylinder 120, 122 to dump the calculated amount of payload from the implement 118. For example, when the current weight of payload in the implement 118 is 10 tons and the calculated amount of payload to be dumped from the implement 118 is 2 tons, the control module 206 may send signals to the hydraulic valves to control the operation of the lift and tilt cylinders 120, 122 to dump 2 tons of the payload from the implement 118.

In order to dump the calculated amount of payload from the implement 118, the control module 206 sends signals to the hydraulic valves to adjust a current position of each of the lift and tilt cylinder 120, 122 and/or a current velocity of each of the lift and tilt cylinder 120, 122 to correspond to a target position of each of the lift and tilt cylinder 120, 122 and/or or a target velocity of each of the lift and tilt cylinder 120, 122. In some situations, the control module 206 may send signals to adjust the current position and/or the current velocity of the tilt cylinder 122 alone to dump the calculated amount of payload from the implement 118. The term “target position and target velocity” refers to a position and a velocity of the respective lift cylinder 120 and the tilt cylinder 122 that corresponds to the calculated amount of payload. The current position and/or current velocity of the lift and tilt cylinders 120, 122 are determined by differentiating signals received from position sensors. Each of the lift cylinder 120 and the tilt cylinder 122 respectively include a lift position sensor 210 and a tilt position sensor 212 that generates signals that are processed to determine the current position of the lift and tilt cylinders 120, 122 respectively.

Further, the control module 206 compares the current position and/or current velocity of the lift and tilt cylinder 120, 122 with the corresponding target position and/or target velocity. Based on the comparison, the control module 206 sends signals to the hydraulic implement controller 204 to adjust the current position and/or current velocity of the lift and tilt cylinder 120, 122 to dump the calculated amount of payload from the implement 118.

In order to determine whether the calculated amount of payload is dumped from the implement 118, the control module 206 may receive signals corresponding to the weight of payload present in the implement 118 during the dump operation of the calculated amount of payload. At an instance when the control module 206 determines that the calculated amount of payload is dumped from the implement 118, the control module 206 generates signals for termination of the dump operation. For example, when the calculated amount of payload to be dumped from the implement 118 is 2 tons and the current weight of payload in the implement 118 is 10 tons, the control module 206 may terminate the dump operation when the weight of payload in the implement 118 corresponds to 8 tons. In another example, the control module 206 may send signals to terminate the dump operation prior to the predetermined threshold being met, such that when the payload stops flowing, the current weight of payload in the implement 118 corresponds to the predetermined threshold.

Once the dump operation is complete, the control module 206 may control the implement 118 to a rack back position. Further, in a situation where the operator of the machine 102 wishes to terminate the dump operation, the operator may operate or release the lever 124 to send the deactivation signal to the control module 206. Based on the receipt of the deactivation signal, the control module 206 may terminate the raise and dump operations.

As shown in the accompanying figures, an output module 214 is communicably coupled with the control module 206. The output module 214 provides a notification to the operator of the machine 102 regarding the current weight of payload in the implement 118. The output module 214 is communicably coupled to the control module 206 in a wired or wireless manner. The output module 214 may be mounted at a location such that the output module 214 may be viewable to the operator. For example, the output module 214 may be present in the operator cabin 126 of the machine 102, and may be viewable on the operator interface. Alternatively, the output module 214 may form a part of a dashboard of the machine 102, and may be provided adjacent to a speedometer or a fuel level indicator.

The output module 214 may embody a visual output or an audio output. In one example, in case of an audible output, an alarm generated by the output module 214 may notify the operator of the current weight of payload. In another example, wherein the output module 214 is embodied as a visual output, the output module 214 may include any one of a digital display device, a Liquid Crystal Display (LCD) device, a Light-Emitting Diode (LED) device, a cathode ray tube (CRT) monitor, a touchscreen device, or any other display device known in the art. In one example, the output module 214 may notify the operator regarding the current weight of payload through a text message. In a situation wherein the output module 214 is embodied as the audio output, an audio clip may be heard; thereby notifying the operator regarding the current weight of payload. It should be noted that the output module 214 may include any other means other than those listed above.

The control module 206 may embody a single microprocessor or multiple microprocessors that include components for controlling operations of the implement 118 based on inputs from the operator and based on sensed or other known operational parameters. Numerous commercially available microprocessors can be configured to perform the functions of the control module 206. It should be appreciated that the control module 206 could readily be embodied in a general machine microprocessor capable of controlling numerous machine functions.

The control module 206 may include a memory, a secondary storage device, a processor, and any other components for running an application. Various routines, algorithms, and/or programs can be programmed within the control module 206 for execution thereof. A person of ordinary skill in the art will appreciate that the control module 206 may additionally include other components and may also perform other functions not described herein. Further, the system 200 may include additional modules (not shown) in order to implement the described functionality of the system 200.

### INDUSTRIAL APPLICABILITY

The system 200 allows the tipping of an accurate amount of payload from the implement 118 to achieve a final truck payload target. The system 200 of the present disclosure calculates the amount of payload to be dumped from the implement 118 of the machine 102. Further, the current weight of payload is measured during the lifting motion “M” of the implement 118 which in turn improves weight measurement accuracy of the system 200 and avoids implement tip contact with the pile or the truck 104. Based on the determination, the system 200 controls the movement of the implement 118 to dump the calculated amount of payload. Further, in order to determine whether the calculated amount of payload is dumped from the implement 118, the control module 206 of the system 200 dynamically monitors the weight of the payload in the implement 118 during the dump operation of the calculated amount of payload.

In order to tip the accurate amount of payload, the movement of the implement 118 is controlled to achieve a smooth action for the payload to consistently fall from the implement 118. Further, the control module 206 also controls the lift motion of the implement 118 to reduce/eliminate friction that may affect the accuracy of the dump operation.

The system 200 disclosed herein is reliable in operation. Also, the system 200 makes use of existing sensing devices that are present on board the machines 102, and hence presents a cost effective solution. Further, the system 200 provides an accurate and easy to implement solution for tipping the accurate amount of payload from the implement 118. The system 200 also eliminates requirement of skilled labor for tipping of the payload from the implement 118. Hence, cost associated with skilled labor may be eliminated.

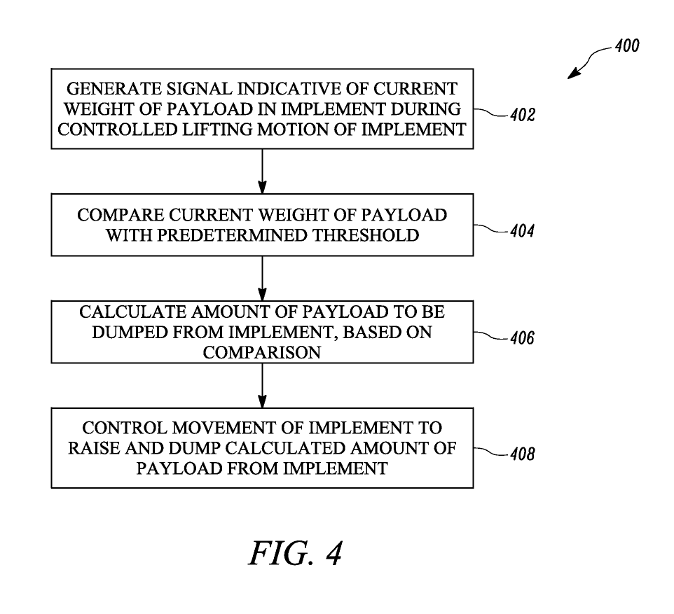

FIG. 4 is a flowchart for a method 400 of controlling the movement of the implement 118 during the dump operation. At step 402, the payload detection module 202 generates the signal indicative of the current weight of payload in the implement 118, during the controlled lifting motion “M” of the implement 118. The payload detection module 202 includes pressure sensors to determine the current weight of payload in the implement 118. The pressure sensor may be coupled with the lift cylinder 120, the tilt cylinder 122, and the implement 118. In one exemplary embodiment, the calculated amount of payload in the implement 118 can be displayed on the output module 214. At step 404, the control module 206 compares the current weight of payload in the implement 118 with the predetermined threshold. At step 406, the control module 206 calculates the amount of payload to be dumped from the implement 118, based on the comparison.

At step 408, the control module 206 controls the movement of the implement 118 to dump the calculated amount of payload from the implement 118. The control module 206 determines the target position and/or target velocity of each of the lift cylinder 120 and the tilt cylinder 122 that corresponds with the calculated amount of payload. Further, the control module 206 compares the current position and/or current velocity of each of the lift cylinder 120 and the tilt cylinder 122 with the target position and/or target velocity of each of the lift cylinder 120 and the tilt cylinder 122 respectively. The current position and/or current velocity of the lift cylinder 120 and the tilt cylinder 122 are determined by differentiating the signals received from the position sensors 210, 212. Based on the comparison, the control module 206 dumps the calculated amount of payload from the implement 118 by adjusting the current position and/or current velocity of each of the lift cylinder 120 and the tilt cylinder 122. The hydraulic implement controller 204 is configured to adjust the current position and/or the current velocity of each of the lift cylinder 120 and the tilt cylinder 122.

The payload detection module 202 also detects the current weight of payload in the implement 118 during the dump operation. Further, the control module 206 receives the signals indicative of the current weight of payload and compares the current weight of payload with the predetermined threshold. The control module 206 controls the dump operation based on the comparison between the current weight of payload and the predetermined threshold. More particularly, the control module 206 may terminate the dump operation when the current weight of payload in the implement 118 during the dump operation corresponds to the predetermined threshold. In another example, the control module 206 may terminate the dump operation prior to the predetermined threshold being met, such that when the payload stops flowing, the current weight of payload in the implement 118 corresponds to the predetermined threshold.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for controlling a movement of an implement during a dump operation, the system comprising:
a payload detection module associated with the implement, the payload detection module configured to generate a signal indicative of a current weight of payload in the implement, wherein the payload detection module determines the current weight of payload during a controlled lifting motion of the implement; and
a control module communicably coupled to the payload detection module, the control module configured to:
receive the signal indicative of the current weight of payload in the implement;
compare the current weight of payload with a predetermined threshold;
calculate an amount of payload to be dumped from the implement, based on the comparison; and
control the movement of the implement to dump the calculated amount of payload from the implement.

2. The system of claim 1 further comprising an output module communicably coupled to the control module, the output module configured to display the calculated amount of payload to be dumped from the implement.

3. The system of claim 1, wherein the payload detection module includes a pressure sensor, the pressure sensor coupled with at least one of a lift cylinder, a tilt cylinder, and the implement.

4. The system of claim 1, wherein the control module is further configured to:
determine at least one of a target position of each of a lift cylinder and a tilt cylinder and a target velocity of each of the lift cylinder and the tilt cylinder that corresponds with the calculated amount of payload;
compare at least one of a current position of each of the lift cylinder and the tilt cylinder and a current velocity of each of the lift cylinder and the tilt cylinder with the target position and target velocity of each of the lift cylinder and the tilt cylinder respectively; and
dump the calculated amount of payload from the implement by adjusting at least one of the current position of each of the lift cylinder and the tilt cylinder and the current velocity of each of the lift cylinder and the tilt cylinder, based on the comparison.

5. The system of claim 4, wherein at least one of the current position of each of the lift cylinder and the tilt cylinder and the current velocity of each of the lift cylinder and the tilt cylinder is determined by differentiating signals received from a position sensor.

6. The system of claim 4, wherein a hydraulic implement controller is communicably coupled to the control module, the lift cylinder, and the tilt cylinder, wherein the hydraulic implement controller is configured to adjust at least one of the current position of each of the lift cylinder and the tilt cylinder and the current velocity of each of the lift cylinder and the tilt cylinder.

7. The system of claim 1, wherein the control module is further configured to:
determine the current weight of payload in the implement during the dump operation,
compare the current weight of payload with the predetermined threshold; and
control the dump operation based on the comparison.

8. A method of controlling a movement of an implement during a dump operation; the method comprising:
generating a signal indicative of a current weight of payload in the implement during a controlled lifting motion of the implement;
comparing the current weight of payload with a predetermined threshold;
calculating an amount of payload to be dumped from the implement, based on the comparison; and
controlling the movement of the implement to raise and dump the calculated amount of payload from the implement.

9. The method of claim 8 further comprising:
displaying the calculated amount of payload in the implement on an output module.

10. The method of claim 8, wherein the current weight of payload in the implement is determined using a pressure sensor, the pressure sensor coupled with at least one of a lift cylinder, a tilt cylinder, and the implement.

11. The method of claim 8 further comprising:
determining at least one of a target position of each of a lift cylinder and a tilt cylinder and a target velocity of each of the lift cylinder and the tilt cylinder that corresponds with the calculated amount of payload;
comparing at least one of a current position of each of the lift cylinder and the tilt cylinder and a current velocity of each of the lift cylinder and the tilt cylinder with the target position and target velocity of each of the lift cylinder and the tilt cylinder respectively; and
dumping the calculated amount of payload from the implement by adjusting at least one of the current position of each of the lift cylinder and the tilt cylinder and the current velocity of each of the lift cylinder and the tilt cylinder, based on the comparison.

12. The method of claim 11, wherein a hydraulic implement controller is configured to adjust at least one of the current position of each of the lift cylinder and the tilt cylinder and the current velocity of each of the lift cylinder and the tilt cylinder.

13. The method of claim 11, wherein the current position of each of the lift cylinder and the tilt cylinder and the current velocity of each of the lift cylinder and the tilt cylinder is determined by differentiating signals received from a position sensor.

14. The method of claim 11 further comprising:
detecting the current weight of payload in the implement during the dump operation,
comparing the current weight of payload with the predetermined threshold; and
control the dump operation based on the comparison.

15. A machine comprising:
a frame;
a linkage member coupled to the frame;
an implement coupled to the linkage member, the implement configured to hold payload therein;
a payload detection module associated with the implement, the payload detection module configured to generate a signal indicative of a current weight of payload in the implement, wherein the payload detection module determines the current weight of payload during a controlled lifting motion of the implement; and
a control module communicably coupled to the payload detection module, the control module configured to:
receive the signal indicative of the current weight of payload in the implement;
compare the current weight of payload with a predetermined threshold;
calculate an amount of payload to be dumped from the implement, based on the comparison; and
control a movement of the implement to dump the calculated amount of payload from the implement.

16. The machine of claim 15, wherein the payload detection module includes a pressure sensor, the pressure sensor coupled with at least one of a lift cylinder, a tilt cylinder, and the implement.

17. The machine of claim 15, wherein the control module is further configured to:
determine at least one of a target position of each of a lift cylinder and a tilt cylinder and a target velocity of each of the lift cylinder and the tilt cylinder that corresponds with the calculated amount of payload;
compare at least one of a current position of each of the lift cylinder and the tilt cylinder and a current velocity of each of the lift cylinder and the tilt cylinder with the target position and target velocity of each of the lift cylinder and the tilt cylinder respectively; and
dump the calculated amount of payload from the implement by adjusting the at least one of the current position of each of the lift cylinder and the tilt cylinder and the current velocity of each of the lift cylinder and the tilt cylinder, based on the comparison.

18. The machine of claim 17, wherein a hydraulic implement controller is communicably coupled to the control module, the lift cylinder, and the tilt cylinder, the hydraulic implement controller configured to adjust at least one of the current position of each of the lift cylinder and the tilt cylinder and the current velocity of each of the lift cylinder and the tilt cylinder.

19. The machine of claim 17, wherein the current position of each of the lift cylinder and the tilt cylinder and the current velocity of each of the lift cylinder and the tilt cylinder is determined by differentiating signals received from a position sensor.

20. The machine of claim 15, wherein the control module is further configured to:
determine the current weight of payload in the implement during the dump operation,
compare the current weight of payload with the predetermined threshold; and
control the dump operation based on the comparison.
